(19) United States
(12) Patent Application Publication
(10) Pub. No.: US 2006/0159138 A1
(43) Pub. Date: Jul. 20, 2006

(54) Pulsed laser light source

(75) Inventors: Pascal Deladurantaye, St-Joseph De La Pointe-Levy (CA); Yves Taillon, Saint-Augustin De Desmaures (CA); Robert Larose, Laval (CA)

Correspondence Address: MERCHANT & GOULD PC, P.O. BOX 2903, MINNEAPOLIS, MN, 55402-0903, US

(73) Assignee: INSTITUT NATIONAL D'OPTIQUE, Sainte-Foy, QC (CA)

(21) Appl. No.: 11/316,568

(22) Filed: Dec. 21, 2005

Related U.S. Application Data
(60) Provisional application No. 60/637,460, filed on Dec. 21, 2004.

(51) Int. Cl. H01S 3/10; H01S 3/13

(52) U.S. Cl. 372/25; 372/26; 372/30

(57) ABSTRACT

A pulsed laser light source is provided. A continuous light beam is first generated by a CW laser source such as a laser diode, a superfluorescent source or a CW solid state laser. The continuous light beam is then modulated by a first modulator, and further shaped by a second modulator at least in partial synchronization with the first. The first and second modulators are preferably each followed by a gain medium for signal amplification.

### FIELD OF THE INVENTION

The present invention relates to the field of laser light sources and more particularly concerns a pulsed laser source which provides optical output pulses with temporal shape flexibility.

### BACKGROUND OF THE INVENTION

Pulsed laser sources are currently of considerable interest in a variety of fields such as material processing, range finding, remote detection or communication-related applications. It is usually desirable to produce a high peak power from a pulsed laser. Three main techniques are generally used for that purpose: Q-switching, mode-locking, and gated cascade amplification.

The Q-switching method consists of switching from a high-loss to a low-loss condition in a laser cavity. A Q-switched laser system typically comprises a gain medium, pumped by laser diodes or other external pumping source, and a mirror on each side thereof to generate the laser oscillation. The switching between a high-loss and low-loss condition is generally obtained with a high speed switching device such as an acousto-optic modulator. Before switching to the low-loss condition, the gain medium is fully inverted and presents its maximum gain. Reverting rapidly to a low-loss cavity enables the build-up of a powerful pulse in the laser. The resulting peak power is fairly large, but the spectrum is often composed of several longitudinal modes and the repetition rate is generally low due to the limited repetition frequency of the switching device. Moreover, the pulsewidth is not directly adjustable, and it varies with the pumping rate, the repetition rate and the cavity optical length. Another drawback is a “jitter” of the output beam, that is, substantial variations of the delay between the moment when the pulse is triggered and the launching of the laser output pulse.

Mode-locking is another technique to obtain high peak power and short pulses, by synchronizing most of the longitudinal modes of the laser cavity with an internal modulator. Typically the driving frequency of the modulator corresponds to the round-trip time of the cavity and has to be precisely tuned. Therefore, the repetition rate of a mode-locked laser is fixed as well as the pulsewidth, since they are determined by the physics of the cavity.

In order to have control over both the repetition rate and the pulsewidth, one can use a gated cascade amplification scheme. A low power laser diode is first pulsed with the right repetition rate and pulsewidth and acts as a seed for a series of amplifiers, which increase the pulses power. The amplifiers are usually gated with synchronously activated switches in order to limit the self-saturation of the gain in the amplifier chain by its own noise coming from amplified spontaneous emission. This configuration has the advantage of separating the pulse generation from the amplification process, both the spectral and temporal quality of the laser output pulses then depending only on the laser diode source. Directly pulsing the laser diode current can however generate transient effects that can affect both the spectrum and the noise figure of the seed source. Furthermore, longitudinal mode beating can be an important source of high frequency noise which consequently gives rise to peak power fluctuations in the pulse structure. Depending on its amplitude and frequency spectrum, this noise can severely limit one's ability to generate stable optical pulses having special shapes with fine structures.

There is therefore a need for a stable pulsed fiber laser with easy control over the repetition rate and the pulsewidth and which also provides a pulse shaping capability at a fine level.

Alleviating the drawbacks of the above-mentioned prior art is the laser source disclosed in U.S. Pat. No. 6,148,011 (LAROSE et al.). LAROSE et al teaches of a self-seeded laser source including a waveguide, an optical pump source, a gain medium to produce seed radiation, and a modulator and an array of Bragg gratings to modify the properties of the seed radiation (see FIG. 1A (PRIOR ART)). Once generated by the gain medium, the seed radiation propagates in the waveguide where it is first pulsed by the modulator. The resulting pulses are then selectively reflected by the Bragg grating, which separates different spectral components of the reflected beam. This reflected beam then travels back to the modulator, which is timed to let only the desired spectral components go through. In this manner, the laser is self-seeded and allows spectrum and wavelength selection from pulse to pulse. Optionally, a second gain medium may be provided between the modulator and Bragg grating to provide further amplification of the signal.

A drawback of the self-seeded source of LAROSE et al. is that the obtained pulse shape includes a step or “pedestal” preceding the desired pulse associated with residual ASE when the second gain medium is used. This is illustrated in FIG. 1B (PRIOR ART). A second drawback of the self-seeded source of LAROSE et al. is that the modulator extinction ratio must be high in order to prevent spurious lasing of the source due to the parasitic back reflections coming from the output isolator or from other components such as the pump couplers. This ultimately limits the maximum achievable output power of the source and its stability, depending on both the modulator extinction ratio and the back reflection level of the other optical components. It would therefore be advantageous to provide a pulsed laser source which alleviates these drawbacks, and additionally provides an even greater stability and versatility in the time domain than prior art devices.

### SUMMARY OF THE INVENTION

The present invention therefore provides a pulsed laser light source, which first includes a continuous wave light source for generating a continuous light beam. A first modulator receiving the continuous light beam therethrough is provided for temporally modulating this continuous light beam so as to generate a plurality of optical pulses having a pulse shape, said pulses defining a pulsed light beam. A second modulator receiving the pulsed light beam therethrough is also provided, and temporally modulating the pulsed light beam in at least a partial synchronization with the first modulator so as to further determine the pulse shape of said optical pulses.

In accordance with a preferred embodiment of the invention, there is also provided a pulsed laser light source which includes a continuous wave light source for generating a continuous light beam, and a pulse generation stage optically coupled to this continuous wave light source for receiving the continuous light beam therefrom. The pulse generation stage includes a first modulator for temporally modulating the continuous light beam so as to generate a plurality of optical pulses having a pulse shape, said optical pulses defining a pulsed light beam, and a first gain medium for amplifying the pulsed light beam.

The pulsed laser light source further comprises a pulse shaping stage optically coupled to the pulse generation stage for receiving the pulsed light beam therefrom, the pulse shaping stage including a second modulator for temporally modulating the pulsed light beam in at least a partial synchronization with the first modulator so as further determine the pulse shape of the optical pulses. The pulse shaping stage further includes a second gain medium downstream the second modulator for further amplifying the pulsed light beam.

Other features and advantages of the present invention will be better understood upon reading preferred embodiments thereof with reference to the appended drawings.

### BRIEF DESCRIPTION OF THE DRAWINGS

FIG. 1A (PRIOR ART) is a schematic representation of a self-seeded laser source according to prior art; FIG. 1B (PRIOR ART) illustrates the temporal shape of a pulse generated by the source of FIG. 1A.

FIG. 2 is a conceptual illustration of a pulsed laser light source according to one embodiment of the present invention.

FIG. 3 is a schematized representation of the pulsed laser light source according to another embodiment of the invention.

FIGS. 4A and 4B are graphs showing a first example of the temporal shape of first and second drive signals for the first and second modulators respectively.

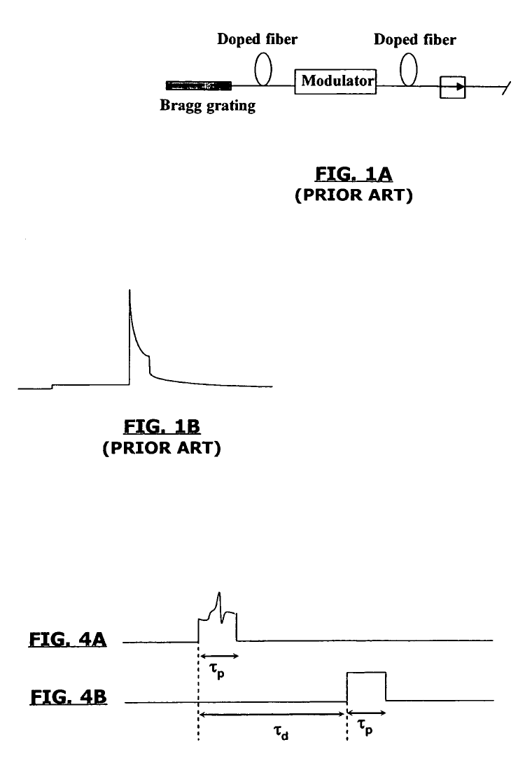

### DESCRIPTION OF PREFERRED EMBODIMENTS OF THE INVENTION

Referring to FIG. 2, there is shown a pulsed laser light source according to a preferred embodiment of the invention.

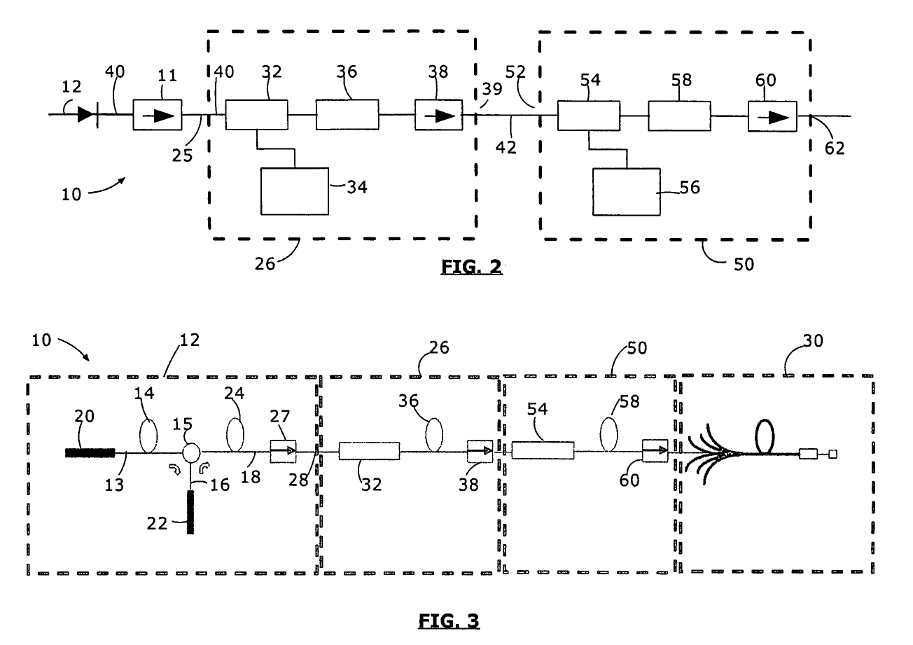

The pulsed laser source 10 first includes a continuous wave (CW) light source 12 generating a continuous light beam 40. In the embodiment of FIG. 2, the CW light source is a laser diode, but any other light source generating an appropriate continuous beam could be considered, such as for example a superfluorescent source (see description of FIG. 3 below), a CW fiber laser or a fiber coupled CW bulk solid-state laser source. The continuous light beam 40 preferably has a spectral shape which will determine the spectral shape of the light outputted by the entire pulsed light source 10. Advantageously, the laser diode may be selected or replaced depending on the required spectral profile of the outputted light. Alternatively, a wavelength tunable source may be used. Additional components may optionally be provided downstream the laser diode to modify its spectral shape. An optical isolator 11 may also be provided downstream the laser diode to prevent feedback noise from reaching the CW laser light source 12.

The pulsed laser light source 10 further includes a first modulator 32 for temporally modulating the continuous light beam 40, and thereby generate a plurality of optical pulses defining a pulsed light beam 42. The created optical pulses have a pulse shape determined by the shape of the signals driving the modulator as will be explained further below. The first modulator 32 is preferably an electro-optic modulator, but any other modulation scheme, such as based on an acousto-optic modulator, an electro absorption modulator, etc. could also be considered within the scope of the present invention. The first modulator 32 is preferably provided within a pulse generation stage 26 having an input 25 optically coupled to the cw source 12 to receive the continuous light beam 40 therefrom. It will be understood by one skilled in the art that additional optical components such as mirrors, lenses, spectral shaping elements or any other appropriate element may be provided between the cw light source 12 and the pulse generation stage 26 without departing from the scope of the present invention.

Preferably, a first pulse generator 34 is provided for generating a drive signal which is sent to the first modulator 32. The first drive signal drives the modulator in order to modulate the continuous light beam according to an appropriate repetition rate and shape. Each of the drive pulses produced by the pulse generator has an adjustable width τₚ, defining the period of time the modulator will be open to allow passage of light, and a shape, which is used to shape the intensity of the light allowed to pass through the modulator during the period of time the modulator is open. An example of a pulse shape of the first drive signal is shown in FIG. 4A. In this example, the pulse shape is irregular, such as may for example be desired for particular applications such as for example selective ablation, drilling or other material processing-related applications. The pulse may however be rectangular shaped or have any other desired variation in time.

The pulse generation stage 26 also preferably includes a first gain medium 36, positioned downstream the first modulator 32 for amplifying the pulsed light signal generated thereby. In the preferred embodiment, the first gain medium 36 is a length of optical fiber doped with a rare earth element, such as Er, Yb, Nd, etc. An appropriate pump signal (not shown), propagating either backward or forward through the first gain medium 36, maintains the required population inversion therein. An isolator 38 is also preferably provided prior to the output 39 of the pulse generation stage 26.

The pulsed light source next includes a second modulator 54 which also temporally modulates the pulsed light beam 42. The second modulator 54 is preferably part of pulse shaping stage 50, having an input 52 optically coupled to the output 39 of the pulse generation stage 26 for receiving the pulsed light beam 42 therefrom. The pulse shaping stage 50 also includes a second gain medium 58 preferably provided downstream the second modulator. As for the first gain medium 36, in the preferred embodiment the second gain medium 58 is a length of optical fiber doped with a rare earth element, such as Er, Yb, Nd, etc. An appropriate pump signal (not shown), propagating either backward or forward through the second gain medium 58, maintains the required population inversion therein. An isolator 60 is preferably provided prior to the output 62 of the amplification stage 50.

A second pulse generator 56 is preferably connected to the second modulator 54 and provides a second drive signal. As with the first drive signal, the second modulator drive signal can be made of a plurality of different drive pulses of predetermined widths τₚ and shapes selected according to their desired effect on the pulsed light beam 42. The shape of the drive pulses of the second drive signal may simply be rectangular as shown in FIG. 4B, or may present a more complex irregular shape.

The final shape of the optical pulses of the pulsed light beam will be determined by both modulators. The first and second modulators may be partially or completely synchronized with each other, depending on the desired shape of the resulting pulses of the pulsed light beam. The term “synchronized” is used herein as describing the joint timing of the opening and closing of the first and second modulators, taking into account the travel time τ_{d} of light between both modulators. For example, the two modulators will be considered fully synchronized if the second modulator opens exactly at the instant the leading edge of the pulse generated by the first modulator reaches it, and closes at the instant this pulse ends. It is an advantageous aspect of the invention that the synchronicity between the two modulators may be used advantageously to control the width and shape of the pulses of the pulsed light beam. For example, by setting the two modulators partially out of synchronization, pulses of a very small width may be obtained. Combining drive pulses of different width and shapes may also advantageously be used to tailor the resulting pulses of the pulsed light beam to a wide range of specifications. Moreover, the second modulator also helps to avoid or to limit the saturation of the amplifier stages located downstream since it is maintained in the maximum extinction state during most of the interpulse time period. In this way, the ASE background generated by the gain medium 36 is blocked by the modulator 54 during the interpulse time, this background would otherwise partially deplete the population inversion in the gain medium 58 and potentially in any gain medium located downstream, which could limit the laser output pulse peak power to a lower value due to the reduced extractable energy.

Referring to FIG. 3, there is shown a pulsed light source according to an alternative embodiment of the invention. In this case, the CW light source 12 is embodied by a superfluorescent source which includes a waveguide 13, preferably a length of optical fiber, provided with a Bragg grating 20 and a first source gain medium 14. The first source gain medium 14 is preferably composed of a first length of optical fiber, integral to the waveguide and doped with rare-earth atoms, for example erbium, neodymium, ytterbium, etc. The first source gain medium 14 is pumped to create a population inversion therein. The pump (not shown) may propagate in either direction in the waveguide 13. Forwardly of the first source gain medium 14 is a 3-ports circulator 15 connecting the waveguide 13 in series with two additional waveguide segments 16 and 18. The first additional waveguide 16 is provided with a Bragg grating 22, which preferably has its maximum of reflectivity at the same wavelength than the grating 20 in the waveguide 13. A second source gain medium 24 is disposed in the second additional waveguide segment 18. Both additional waveguide segments 16 and 18 are preferably made of optical fiber and the second source gain medium 24 is preferably a rare-earth doped length of fiber integral to the second additional waveguide segment 18. Optionally, an additional source gain medium (not shown) can be inserted in the first additional waveguide 16 between the circulator and the Bragg grating 22. An isolator 27 is preferably provided in the second additional waveguide segment 18 proximate to the output 28 of the cw source 12.

The CW source 12 generates a CW light signal as follows: the pumped first source gain medium 14 generates constant radiation of a given bandwidth by a process called Amplified Spontaneous Emission (ASE), propagating in the waveguide along both directions. The rearwardly propagating ASE is partially reflected and filtered by the Bragg grating 20 and is amplified again as it propagates in the pumped first source gain medium 14 in the forward direction before reaching the circulator. The signal entering the circulator has therefore two components, namely the broadband ASE background emitted in the forward direction by the first source gain medium 14 and the filtered and amplified radiation just described. As it propagates through the circulator the signal is sent to the first additional waveguide 16 where it is reflected by the Bragg grating 22. The broadband ASE background lying outside the bandwidth of the Bragg grating 22 is then removed, whereas the narrow bandwidth part of the incoming signal is reflected by the grating and is sent forwardly by the circulator into the second additional waveguide 18, where it is further amplified by the second gain medium 24, and outputted through an isolator. The resulting laser source signal is therefore CW and spectrally designed through reflections onto Bragg gratings 20 and 22 according to the needs of a specific application.

As explained above, the pulsed light source 10 of FIG. 3 includes a pulse generation stage 26 provided with a first modulator 32, a first amplifier 36 and an isolator 38. A pulse shaping stage 50 is then provided with a second modulator 54, a second amplifier 58 and an isolator 60. The first and second modulators are preferably driven by first and second drive signals provided by pulse generators (not shown in FIG. 3) as explained above. The first and second amplifiers are preferably embodied by rare-earth doped lengths of optical fibers. Is has been found advantageous for some applications to use ytterbium as dopant for the first amplifier, and neodymium for the second.

The CW source 12, pulse generation stage 26 and pulse shaping stage 50 form together a master oscillator producing optical pulses of well defined temporal shapes produced by the use of a two modulator system. The pulsed signal outputted from the pulse shaping stage 50 may be amplified one last time by power amplifier 30, of well known construction. In the preferred embodiment the waveguide and gain medium therein of the power amplifier is embodied by LMA double clad fiber.

Advantageously, the source of the present invention separates the spectral and temporal shaping of the resulting light pulses, giving a greater versatility in the choice of both these characteristics. As the seed source emits in a CW regime it is not plagued by transient effects that can occur in a configuration where the current of a laser diode is modulated to produce the pulses. In the embodiment of FIG. 3, the superfluorescent source has the additional advantage of generating an emission free of mode beating noise as there is no laser cavity in this configuration. The present invention also alleviates the drawbacks of the self-seeded source of LAROSE et al. as the pulses are not preceded by a pedestal in the time domain and as the chain is isolated in one direction, which relaxes the constraint of having modulators with a very high extinction ratio.

Of course, numerous modifications could be made to the embodiments described above without departing from the scope of the present invention.

1. A pulsed laser light source, comprising:
a continuous wave laser light source generating a continuous light beam;
a first modulator receiving the continuous light beam therethrough and temporally modulating the same so as to generate a plurality of optical pulses having a pulse shape, said pulses defining a pulsed light beam; and
a second modulator receiving the pulsed light beam therethrough and temporally modulating the same in at least a partial synchronization with said first modulator so as to further determine the pulse shape of said optical pulses.

2. The pulsed laser light source according to claim 1, wherein said continuous wave laser light source comprises a laser diode.

3. The pulsed laser light source according to claim 2, wherein said continuous wave laser light source is spectrally tunable.

4. The pulsed laser light source according to claim 1, wherein said continuous wave laser light source comprises a superfluorescent source.

5. The pulsed laser light source according to claim 1, wherein said continuous wave laser light source comprises one of a bulk laser source and a fiber laser source.

6. The pulsed laser light source according to claim 1, further comprising a first gain medium between said first and second modulators.

7. The pulsed laser light source according to claim 6, wherein said first gain medium comprises a length of optical fiber doped with a rare-earth element.

8. The pulsed laser light source according to claim 1, wherein each of said first and second modulators are electro-optical modulators.

9. The pulsed laser light source according to claim 1, further comprising a first pulse generator connected to the first modulator for transmitting a first drive signal thereto.

10. The pulsed laser light source according to claim 9, wherein the first drive signal defines a plurality of drive pulses of a predetermined width, repetition rate and shape.

11. The pulsed laser light source according to claim 10, wherein said predetermined shape is irregular.

12. The pulsed laser light source according to claim 10, wherein said predetermined shape is rectangular.

13. The pulsed laser light source according to claim 9, further comprising a second pulse generator connected to the second modulator for transmitting a second drive signal thereto.

14. The pulsed laser light source according to claim 13, wherein the second drive signal defines a plurality of drive pulses of a predetermined width, repetition rate and shape.

15. The pulsed laser light source according to claim 14, wherein said predetermined shape is rectangular.

16. The pulsed laser light source according to claim 14, wherein said predetermined shape is irregular.

17. The pulsed laser light source according to claim 14, wherein the respective widths of the drive pulses of the first and second drive signals are substantially the same.

18. The pulsed laser light source according to claim 13, wherein said first and second drive signals are synchronized so that said second modulator acts as a gate for the pulses of the pulsed light signal therethrough.

19. The pulsed laser light source according to claim 14, where the repetition rates of the drive pulses of the first and second drive signals are different.

20. The pulsed laser light source according to claim 6, further comprising a second gain medium downstream said second modulator.

21. The pulsed laser light source according to claim 20, wherein said second gain medium comprises a length of optical fiber doped with a rare-earth element.

22. The pulsed laser light source according to claim 1, further comprising at least one power amplification stage downstream said second modulator for amplifying the pulsed light beam therefrom.

23. A pulsed laser light source, comprising:
a continuous wave laser light source for generating a continuous light beam;
a pulse generation stage optically coupled to said continuous wave light source for receiving said continuous light beam therefrom, said pulse generation stage comprising a first modulator for temporally modulating said continuous light beam so as to generate a plurality of optical pulses having a pulse shape, said optical pulses defining a pulsed light beam, and a first gain medium for amplifying said pulsed light beam; and
a pulse shaping stage optically coupled to the pulse generation stage for receiving said pulsed light beam therefrom, said pulse shaping stage comprising a second modulator for temporally modulating said pulsed light beam in at least a partial synchronization with said first modulator so as to further determine the pulse shape of said optical pulses, and a second gain medium downstream said second modulator for further amplifying said pulsed light beam.

24. The pulsed laser light source according to claim 23, wherein said continuous wave laser light source comprises a laser diode.

25. The pulsed laser light source according to claim 24, wherein said continuous wave laser light source is spectrally tunable.

26. The pulsed laser light source according to claim 23, wherein said continuous wave laser light source comprises a superfluorescent light source.

27. The pulsed laser light source according to claim 23, wherein said continuous wave laser light source comprises one of a bulk laser source and a fiber laser source.

28. The pulsed laser light source according to claim 23, wherein said first and second gain media each comprises a length of optical fiber doped with a rare-earth element.

29. The pulsed laser light source according to claim 28, wherein the rare earth element of said first gain medium is ytterbium and the rare earth element of said second gain medium is neodymium.

30. The pulsed laser light source according to claim 23, wherein each of said first and second modulators are electro-optical modulators.

31. The pulsed laser light source according to claim 23, wherein said pulse generation stage further comprises a first pulse generator connected to the first modulator for transmitting a first drive signal thereto.

32. The pulsed laser light source according to claim 31, wherein the first drive signal defines a plurality of drive pulses of a predetermined width, repetition rate and shape.

33. The pulsed laser light source according to claim 31, wherein said pulse shaping stage further comprises a second pulse generator connected to the second modulator for transmitting a second drive signal thereto.

34. The pulsed laser light source according to claim 33, wherein the second drive signal defines a plurality of drive pulses of a predetermined width, repetition rate and shape.

35. The pulsed laser light source according to claim 34, wherein the respective widths of the drive pulses of the first and second drive signals are substantially the same.

36. The pulsed laser light source according to claim 33, wherein said first and second drive signals are synchronized so that said second modulator acts as a gate for the pulses of the pulsed light signal therethrough.

37. The pulsed laser light source according to claim 23, further comprising at least one power amplification stage downstream said pulse shaping stage for further amplifying the pulsed light beam therefrom.
